(19) United States
(12) Patent Application Publication
(10) Pub. No.: US 2025/0376061 A1
(43) Pub. Date: Dec. 11, 2025

(54) Mobile Electric Vehicle (EV) Charging Service Using a Tesla Cybertruck with Additional Batteries

(71) Applicants: Jeffry Allan Johnson, La Marque, TX (US); Jacob Goralski, Kennedale, TX (US)

(72) Inventors: Jacob Goralski, Kennedale, TX (US); Jeffry Allan Johnson, La Marque, TX (US)

(21) Appl. No.: 18/735,013

(22) Filed: Jun. 5, 2024

(51) Int. Cl. B60L 53/57; B60L 53/53

(52) U.S. Cl. CPC B60L 53/57; B60L 53/53

(57) ABSTRACT

The present invention provides a mobile EV charging service utilizing a MCV equipped with additional battery packs located in the bed of the vehicle. The service features a power management system configured to control the transfer of electrical energy from the additional battery packs to a stranded EV or an EV at a customer-requested location. It also includes proprietary charging stations situated in storage units and similar locations, each equipped with an electric meter, to recharge the additional battery packs, ensuring minimal downtime for MCV operations. This solution addresses range anxiety and enhances convenience by offering on-demand mobile charging services, optimizing charging efficiency, and ensuring compatibility with various EV models. This solution also is designed to evolve with advancements in EV technologies, ensuring ongoing compatibility and relevance in the rapidly developing EV ecosystem.

### BACKGROUND OF THE INVENTION

The increasing adoption of the Electric Vehicle (EV) is a pivotal shift towards reducing carbon emissions and fostering sustainable transportation. However, as the number of

EVs on the road grows, the demand for accessible and reliable charging infrastructure becomes increasingly critical. While urban centers and well-traveled routes are gradually being equipped with fixed charging stations, there remains a significant gap in service coverage, particularly in remote locations, during long-distance travel, and in emergency situations where traditional charging options may be unavailable.

Existing mobile charging solutions have attempted to fill these gaps, but many rely on fossil fuel-powered generators or non-renewable grid energy, which can diminish the environmental benefits of EVs. Furthermore, these solutions often provide only temporary or emergency coverage, failing to contribute to the broader expansion of the EV charging network.

The present invention introduces a Mobile Charging Vehicle (MCV) designed to expand the EV charging footprint by providing on-demand, sustainable charging services that are powered exclusively by clean renewable energy. This invention not only addresses the immediate needs of EV drivers in under-served areas but also actively contributes to the growth and accessibility of the EV charging grid.

By integrating renewable energy sources, such as solar panels or grid-sourced green energy, the MCV ensures that charging services are both environmentally responsible and widely available. This innovative approach allows for the strategic deployment of charging capabilities in areas where infrastructure is lacking, thereby extending the reach of the EV charging network and supporting the broader adoption of EVs.

The invention's focus on clean energy and mobile flexibility uniquely positions it to be a vital component in the expansion of the EV charging grid. It empowers regions to enhance their EV infrastructure without the immediate need for fixed charging stations, thus accelerating the transition to a more sustainable transportation system.

### SUMMARY OF THE INVENTION

The present invention provides an MCV designed to deliver on-demand, sustainable charging services for EVs. This innovative solution addresses the growing need for reliable and accessible EV charging infrastructure, particularly in areas where fixed charging stations are sparse or non-existent.

The MCV is equipped with a modular battery system that includes one or more supplementary battery packs, allowing it to efficiently charge a wide range of EVs. A key feature of this invention is its exclusive use of clean renewable energy, sourced from the grid or through integrated renewable systems such as solar panels. This ensures that the environmental benefits of EVs are fully preserved, setting this solution apart from conventional mobile chargers that rely on fossil fuels or non-renewable energy sources.

In addition to its environmental benefits, the MCV is designed to be highly versatile and scalable, capable of being deployed in various geographic locations to expand the EV charging footprint. The vehicle is equipped with advanced communication systems that enable real-time interaction with a central dispatch and customer devices, facilitating efficient scheduling and deployment.

The MCV's user interface, accessible via a mobile app, allows customers to easily request charging services, monitor the charging process, and receive updates. The system's design also includes safety features such as thermal management for the batteries and collision detection sensors, ensuring a secure and reliable service.

Overall, this invention offers a comprehensive solution to the challenges of EV charging infrastructure by providing a mobile, renewable energy-powered platform that not only meets immediate charging needs but also contributes to the long-term expansion of the EV charging network.

### BRIEF DESCRIPTION OF DRAWINGS

FIG. 1: Schematic diagram of the mobile EV charging service, illustrating the MCV equipped with supplementary batteries, a power management system, and the charging cable connecting the MCV to a stranded EV.

FIG. 2: Diagram of the proprietary charging station setup used for recharging the supplementary battery packs.

### DETAILED DESCRIPTION OF THE INVENTION

The present invention pertains to a mobile EV charging service, designed to provide on-demand charging solutions using a specially equipped MCV. This invention addresses the increasing demand for reliable and accessible EV charging infrastructure, particularly in areas where fixed charging stations are limited or non-existent.

The MCV is outfitted with a modular battery system that includes one or more supplementary battery packs. These battery packs are engineered to be compatible with a wide range of EV models, ensuring flexibility and efficiency in delivering charging services. The vehicle also integrates an advanced power management system that optimizes the distribution of energy between the MCV's primary battery and the supplementary battery packs, enhancing performance and safety during operation.

A key feature of this invention is its exclusive reliance on clean renewable energy, which can be sourced either from the grid or through integrated renewable energy systems, such as solar panels installed on the MCV. This commitment to green energy ensures alignment with broader environmental sustainability goals, distinguishing it from other mobile charging solutions that may rely on fossil fuels or non-renewable energy sources.

The MCV is equipped with state-of-the-art communication systems that enable real-time interaction with a central dispatch center and customer devices. This connectivity allows for efficient tracking, scheduling, and deployment of the charging service, ensuring that customer needs are met promptly and effectively. The system is designed to be scalable, enabling the deployment of multiple MCVs to cover extensive geographic areas or to manage high-demand scenarios.

The invention also includes a user-friendly interface accessible via a mobile app, allowing customers to easily request charging services, track the arrival of the MCV, and monitor the charging progress. The app provides real-time updates and integrates seamlessly with existing EV infrastructure, making the service accessible to a broad range of EV users.

In terms of safety, the MCV is designed with multiple protective features, including thermal management systems for the batteries, collision detection sensors, and automatic shutdown protocols in case of emergencies. These safety measures ensure that both the operators and the customers are protected during the charging process.

The MCV's supplementary batteries can be recharged at standard EV charging stations or through the proprietary charging station setup designed specifically for this invention. This setup allows for efficient recharging of the battery packs, ensuring the MCV is always ready for deployment.

Overall, this invention offers a comprehensive solution to the challenges of EV charging, providing a mobile, renewable energy-powered platform that not only meets immediate charging needs but also contributes to the broader expansion of the EV charging infrastructure.

### DETAILED DESCRIPTION OF THE PREFERRED EMBODIMENT

In the preferred embodiment of the present invention, the MCV is designed with advanced features to deliver efficient and sustainable EV charging services. This embodiment focuses on maximizing the effectiveness of the charging process while maintaining a strong commitment to environmental sustainability.

### 1. Vehicle Configuration

The MCV is equipped with a robust chassis capable of supporting the weight of the primary and supplementary battery systems. The vehicle design includes a reinforced frame to ensure stability and safety during transport and operation. The MCV is also fitted with an aerodynamic shell to reduce wind resistance, improving overall energy efficiency.

### 2. Modular Battery System

The heart of the MCV is its modular battery system, comprising one or more high-capacity supplementary battery packs. These battery packs are housed in secure compartments within the vehicle, utilizing a custom-designed mounting system that ensures stability and safety. The battery system is designed to be easily replaceable, allowing for quick swaps if a battery pack reaches the end of its operational life or needs servicing.

### 3. Power Management System

A sophisticated power management system governs the flow of energy between the MCV's primary battery and the supplementary battery packs. This system is based on a programmable logic controller (PLC) that continuously monitors the state of charge, energy demands, and operational conditions. The PLC is programmed to prioritize charging customer vehicles while maintaining sufficient energy reserves for the MCV's mobility and operational needs. This ensures that the MCV remains operational even in high-demand scenarios.

### 4. Charging Interface and Connectors

The MCV is equipped with a versatile charging interface that supports various EV models from different manufacturers. The charging connectors are stored in dedicated compartments and are designed to be easily accessible for quick deployment. The preferred embodiment includes fast-charging capabilities, with the ability to deliver high power to the EV, significantly reducing the time required for a full charge.

### 5. Renewable Energy Integration

In alignment with the invention's commitment to sustainability, the MCV integrates means for generating renewable energy to power the vehicle.

### 6. Communication and Control Systems

The MCV is equipped with advanced communication systems that enable seamless interaction with a central dispatch center and customer devices. The vehicle features a high-speed cellular module integrated into the onboard computer, facilitating real-time data transmission. This connectivity allows for efficient scheduling, route optimization, and service updates. The communication system is also designed to support remote diagnostics and updates, ensuring the MCV operates at peak efficiency.

### 7. User Interface and Mobile Application

The MCV's services are accessible through a user-friendly mobile application available on multiple platforms. The app allows customers to request charging services, view the MCV's real-time location, and monitor the progress of their vehicle's charge. The interface is designed with simplicity in mind, providing clear and concise information to the user. The app also integrates payment options and service history for customer convenience.

### 8. Safety Features

Safety is a critical aspect of the preferred embodiment. The MCV is equipped with thermal management systems to prevent overheating of the battery packs during operation. Additionally, the vehicle includes collision detection sensors that activate automatic shutdown protocols in case of an accident or emergency. These safety features ensure that both the operators and customers are protected during the charging process.

### 9. Recharging Setup

The supplementary battery packs within the MCV can be recharged at standard EV charging stations or through a proprietary charging station setup designed specifically for this invention. This setup allows for quick and efficient recharging of the battery packs, ensuring the MCV is always prepared for deployment. The proprietary charging station is designed to optimize energy transfer, reducing downtime and enhancing the overall efficiency of the system.

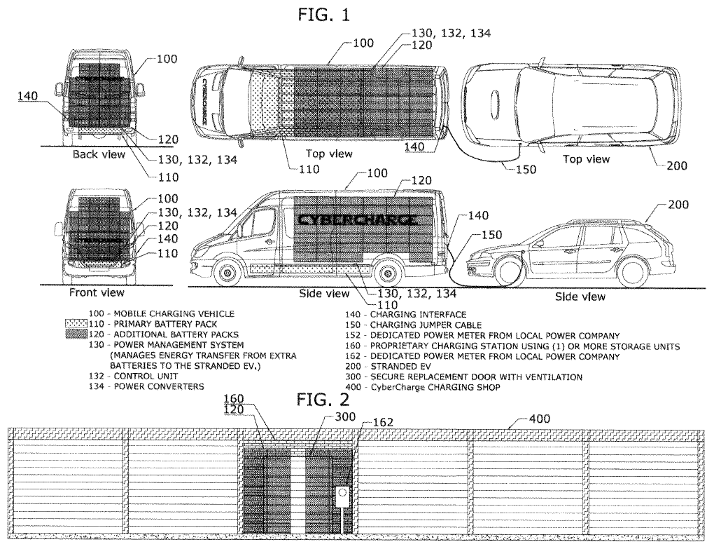

Referring to FIG. 1, the mobile EV charging service comprises an MCV (100) equipped with a primary battery pack (110) and additional battery packs (120) located in the bed of the vehicle. The additional battery packs (120) are connected to a power management system (130) that controls the transfer of electrical energy to the stranded EV (200) or to an EV at a customer-requested location via a charging interface (140). Additionally, item (150) represents the charging jumper cable used to connect the MCV to the stranded EV for charging.

The power management system (130) includes a control unit (132) and power converters (134) to optimize charging efficiency and maintain battery health. The charging interface (140) is designed to be compatible with various EV models, ensuring broad applicability of the mobile charging service. Referring to FIG. 2, the proprietary charging stations (160) are located in storage units and similar locations, each equipped with their own electric meters (162). These charging stations are used to recharge the additional battery packs (120) when they are not in use. The battery packs (120) can be swapped out as needed, ensuring that the MCV (100) is always equipped with fully charged batteries, minimizing downtime for the driver.

Referring to FIG. 2, the proprietary charging stations (160) are in storage units and similar facilities, each equipped with its own electric meter (162). These charging stations are used to recharge the additional battery packs (120) when they are not in use. The battery packs (120) can be swapped out as needed, ensuring that the MCV (100) is always equipped with fully charged batteries, thereby minimizing downtime for the driver.

What is claimed is:

1. A mobile EV charging service including but not limited to:
1) a vehicle with a primary battery pack.
2) one or more additional battery packs located in the bed of the vehicle.
3) a power management system configured to control the transfer of electrical energy from the additional battery packs to an EV.
4) a charging interface configured to connect to the EV.
5) wherein the vehicle is an MCV.
6) wherein the power management system is configured to optimize charging efficiency and battery health.
The mobile EV charging service of claim 1, wherein the power management system includes a control unit and power converters.
The mobile EV charging service of claim 1, including but not limited to a mobile application configured to request and manage the charging service.
The mobile EV charging service of claim 1, wherein the EV is stranded on the road or located at a customer-requested location.
The mobile EV charging service of claim 1, including but not limited to proprietary charging stations located in storage units and similar locations, each equipped with an electric meter, configured to recharge the additional battery packs.
The mobile EV charging service of claim 5, wherein the additional battery packs are configured to be swapped out as needed to ensure the vehicle is always equipped with fully charged batteries. All batteries can be described as a rechargeable power source. The battery packs could be composed of lithium-ion, solid-state, or other rechargeable technologies that provide similar performance characteristics.
The MCV is designed to integrate upcoming enhancements in renewable energy systems, battery technologies, or communication protocols as they become available. The system may also integrate advancements in wireless charging technologies, enabling the MCV to charge EVs without direct cable connections. The communication system is designed to support remote diagnostics, software updates, and integration of new protocols, ensuring the MCV remains at the cutting edge of technology.
The MCV can be configured to support evolving EV charging standards and protocols, ensuring compatibility with next-generation vehicles.
The MCV, as claimed in claim 1, including but not limited to a system for autonomous navigation, allowing the vehicle to operate without human intervention wherein the autonomous navigation system includes but is not limited to LIDAR, GPS, and machine learning algorithms for route optimization.
